(19) United States
(12) Patent Application Publication
(10) Pub. No.: US 2022/0083945 A1
(43) Pub. Date: Mar. 17, 2022

(54) SYSTEM AND METHOD FOR CATALOGING PRODUCTS BASED ON CROSS-SELL ANALYTICS

(71) Applicant: Content Square SAS, Paris (FR)

(72) Inventors: Michael COLOMBIER, Paris (FR); Martin DE CHARETTE, Paris (FR)

(73) Assignee: Content Square SAS, Paris (FR)

(21) Appl. No.: 17/017,989

(22) Filed: Sep. 11, 2020

(51) Int. Cl. G06Q 10/06; G06Q 30/02

(52) U.S. Cl. CPC G06Q 10/06393; G06Q 30/0204

(57) ABSTRACT

A system and method for identifying cross-selling effectiveness. The method includes receiving transaction data on a plurality of products, identifying a product from the plurality of products that are sold together with another product from the plurality of products in a same transaction across a plurality of transactions, determining a Key Performance Indicator (KPI) of the identified product, based on the received transaction data, comparing the KPI of the identified product with the KPI of the other product from the plurality of products, ranking the identified product based on the comparing of the KPIs, determining an insight based on the comparing of the KPIs and the ranking, and making a recommendation based on the insight.

### TECHNICAL FIELD

The present disclosure relates generally to product activity tracking on e-commerce platform, more specifically, the disclosure is directed to a system and method for cataloguing products based on cross-sell analytics.

### BACKGROUND

The Internet is a collection of disparate computer systems which use a common protocol to communicate with each other. A common use of the Internet is to access World Wide Web (web) pages. Web pages are typically stored on a server and remotely accessed by a client over the Internet using a web browser.

A web site is a collection of web pages. A web site includes typically a home page and a hierarchical order of follow on web pages that are accessible through the home page. The web pages are connected to each other using hypertext links. The links allow a user to browse web pages of a web site by selecting the links between the web pages. Distinct Web sites may be respectively identified by respective distinct associated Internet domain names.

Online purchasing has become prominent in recent years. Users are directed to a website that is displayed over the internet where merchandise is displayed purchase. It has been shown that online purchases have replaced traditional brick-and-mortar purchases.

To increase user purchase of products displayed on websites and increase overall revenue, web sites have become very sophisticated in tracking the actions of users online. Web sites typically include web pages that provide information to users and allow the users to purchase the products by simply selecting the images displayed online. However, it is difficult to determine the relationships among the products purchased during each transaction. That is, it is difficult to identify different products that are cross-sold with each other, or how effective the cross-selling of the products are.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for identifying cross-selling effectiveness. The method includes receiving transaction data on a plurality of products, identifying a product from the plurality of products that are sold together with another product from the plurality of products in a same transaction across a plurality of transactions, determining a Key Performance Indicator (KPI) of the identified product, based on the received transaction data, comparing the KPI of the identified product with the KPI of the other product from the plurality of products, ranking the identified product based on the comparing of the KPIs, determining an insight based on the comparing of the KPIs and the ranking, and making a recommendation based on the insight.

Certain embodiments disclosed herein also include a non-transitory computer readable medium having stored thereon causing a processing circuitry to execute a process, the process includes receiving transaction data on a plurality of products, identifying a product from the plurality of products that are sold together with another product from the plurality of products in a same transaction across a plurality of transactions, determining a Key Performance Indicator (KPI) of the identified product, based on the received transaction data, comparing the KPI of the identified product with the KPI of the other product from the plurality of products, ranking the identified product based on the comparing of the KPIs, determining an insight based on the comparing of the KPIs and the ranking, and making a recommendation based on the insight.

Certain embodiments disclosed herein also include a system for identifying cross-selling effectiveness. The system includes a processing circuitry, and a memory. The memory containing instructions that, when executed by the processing circuitry, configure the system to receive transaction data on a plurality of products, identify a product from the plurality of products that are sold together with another product from the plurality of products in a same transaction across a plurality of transactions, determine a Key Performance Indicator (KPI) of the identified product, based on the received transaction data, compare the KPI of the identified product with the KPI of the other product from the plurality of products, rank the identified product based on the comparing of the KPIs, determine an insight based on the comparing of the KPIs and the ranking, and make a recommendation based on the insight.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic network diagram utilized to describe the various disclosed embodiments.

FIG. 2 is a detailed schematic view of the user device, according to an embodiment.

FIG. 3 is a chart depicting sales performance of various products sold within a catalogue, according to an embodiment.

FIG. 4 is a chart showing sales performance of various products sold within a catalogue, according to an embodiment.

FIG. 5 is a chart showing cross-selling data among products, according to an embodiment.

FIG. 6 is a diagram of a method of analyzing an activity of a user, according to an embodiment.

FIG. 7 is a diagram of an analytic engine according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for identifying cross-selling effectiveness of products. Sales data on a plurality of products are received, the sales data including a number of transactions in which each of the plurality of products are sold. A product from the plurality of products that are sold together with at least another product from the plurality of products in a same transaction is identified. A number of times the identified product has been sold together with the at least another product from the plurality of products in the same transaction is determined. Also, a number of conversions for the plurality of products is determined, the number of conversions being a total number of sales transactions that include a particular product, made by visitors to the website. Next, a cross-sale rate for the identified product is determined, based on the number of conversions and the determined number of times the identified product has been sold together with the at least another product from the plurality of products in the same transaction. The identified product is ranked by the determined cross sale rate; and displayed.

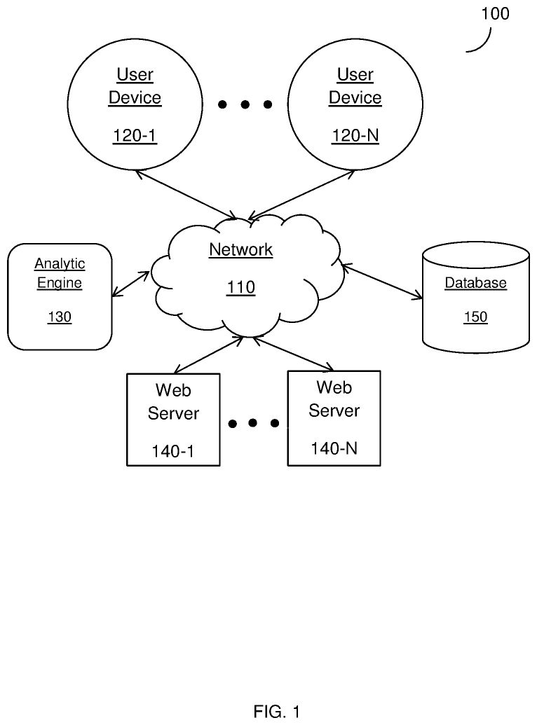

FIG. 1 is an example network diagram depicting a network system 100 utilized to describe the various disclosed embodiments. The system 100 includes one or more user devices, 120-1 through 120-N (hereinafter, “user device” 120 or “user devices” 120), an analytic engine 130, one or more web servers, 140-1 through 140-N (hereinafter “web server” 140 or “web servers” 140), and a database 150 interconnected via a network 110.

The network 110 provides interconnectivity between the various components of the system. The network 110 may be, but is not limited to, a wireless, cellular or wired network, a local area network (LAN), a wide area network (WAN), a metro area network (MAN), the Internet, the worldwide web (WWW), similar networks, and any combination thereof. The network may be a full-physical network, including exclusively physical hardware, a fully-virtual network, including only simulated or otherwise virtualized components, or a hybrid physical-virtual network, including both physical and virtualized components. Further, the network 110 may be configured to encrypt data, both at rest and in motion, and to transmit encrypted, unencrypted, or partially-encrypted data. The network 110 may be configured to connect to the various components of the system 100 via wireless means such as, as examples and without limitation, Bluetooth™, long-term evolution (LTE), Wi-Fi, other, like, wireless means, and any combination thereof, or via wired means such as, as examples and without limitation, ethernet, universal serial bus (USB), other, like, wired means, and any combination thereof. Further, the network 110 may be configured to connect with the various components of the system 100 via any combination of wired and wireless means.

The user devices 120 may be devices allowing a user to interact with the system 100 for purposes including, as examples and without limitation, providing webpage analysis requests to the system 100 for detection and classification of content elements and zones, receiving classification reports from the system 100, configuring system 100 parameters, other, like, purposes, and any combination thereof. The user devices 120 may be devices configured to allow a user to receive information through features such as, as examples and without limitation, video screens, audio speakers, text printers, and other, like, output features. The user devices 120 may be further configured to allow a user to input information. Further, the user devices 120 may be configured to allow users to simultaneously receive and input information, including simultaneously. The user devices 120 may include one or more components configured to provide network connectivity, allowing the user devices 120 to connect with the network 110, including by the means described with respect to the network 110, above. Examples of user devices 120 may be smartphones, personal computers, business systems, dedicated kiosks, tablet computers, and other, like, devices.

The interaction of user devices 120 with the web servers 140 may be performed through a web browser or an application (app) included in each user device 120. The browser, for example, may download webpages from a server 140 and displayed on the device. In an embodiment, any website tracked by the analytic engine 130 their respective web pages may be downloaded to a user device 120 with a tracking tag. The tracking tag is a piece of code (e.g., a script) configured to track an interaction of a user with the web page. This includes a URL visited, any element in the page clicked by, or hover by the user, time spent on a certain web page, purchased made, items placed in a cart, and so on. A website that can be tracked by the engine 130 includes, but is not limited to, an e-commerce website, a social media website, and the like.

The analytic engine 130, depicted in detail with respect to FIG. 8, below, is a system configured to execute instructions, organize information, and otherwise process data. The analytic engine 130 may be configured to execute the methods described hereinbelow, other, like, methods, and any combination thereof. As described with respect to FIG. 8, below, the analytic engine 130 may include various processing, memory, networking, and other components allowing the analytic engine 130 to execute instructions and provide data processing. The analytic engine 130 may be implemented as physical hardware, as software virtualizing physical hardware, or as a combination of physical and virtualized components.

As will be discussed in detail below, the analytic engine 130 is configured to identify products being cross-sold with other products that are driving up group product sales, and determine ways to optimize the identify cross-selling products, separate from products that are purchased alone. Optimization may be done by determining Key Performance Indicators (KPI) for cross-selling products. These KPIs may include a number of conversion for the plurality of products, or a number of times the identified product has been sold together with the at least another product from the plurality of products in the same transaction, and cross-sale rate, which is determined based on the number of conversions, and the determined number of times the identified product has been sold together with the at least another product from the plurality of products in the same transaction.

The web servers 140 may be one or more sources of data other than the inputs received from the user devices 120. The web servers 140 may include data relating to execution of instructions, data relating to the training of models, as described hereinbelow, other, like, data, and any combination thereof. Data from the web servers 140 may be stored in the database 150 and may be processed by the analytic engine 130. Web servers 140 may be local sources, remote sources, or any combination thereof. Examples of web servers 140 include, without limitation, repositories of webpage information, repositories of webpage element or zone classifications, “live” webpages, other, like, sources, and any combination thereof.

Further, where detection of cross-selling performance are achieved via methods including the receipt of product sales data analysis request, such as those described hereinbelow, the product sales data analysis request may include a request for sales data of a specific product in a catalogue of products for sale on a website, by the system executing such a method, from the web servers 140. In addition, where detection of cross-selling performance includes the training of one or more models or algorithms based on a predefined dataset, the dataset including sales data of various products in the catalogue being sold online, may be drawn, by the system training the models or algorithms, from the web servers 140.

The database 150 is a data store configured to archive data permanently or semi-permanently. The database 150 may be configured to store information received from one or more web servers 140, user devices 120, and other, like, components, as well as to store data relevant to the operation of the analytic engine 130 and any outputs therefrom. The database 150 may be a local system, a remote system, or a hybrid remote-local system. Further, the database 150 may be configured as a full-physical system, including exclusively physical components, as a virtualized system, including only virtualized components, or as a hybrid physical-virtual system.

The database 150 may be configured to store or otherwise archive data relating to detection, identification, and classification of webpage zones and elements of interest including, without limitation, webpages, HTML code, Document Object Model (DOM) trees, training datasets, user inputs, other, like, data, and any combination thereof. Further, the database 150 may be configured to transfer, to and from the analytic engine 130, data necessary for the execution of the methods described hereinbelow, and may store or otherwise archive analytic engine 130 inputs, analytic engine 130 outputs, or both.

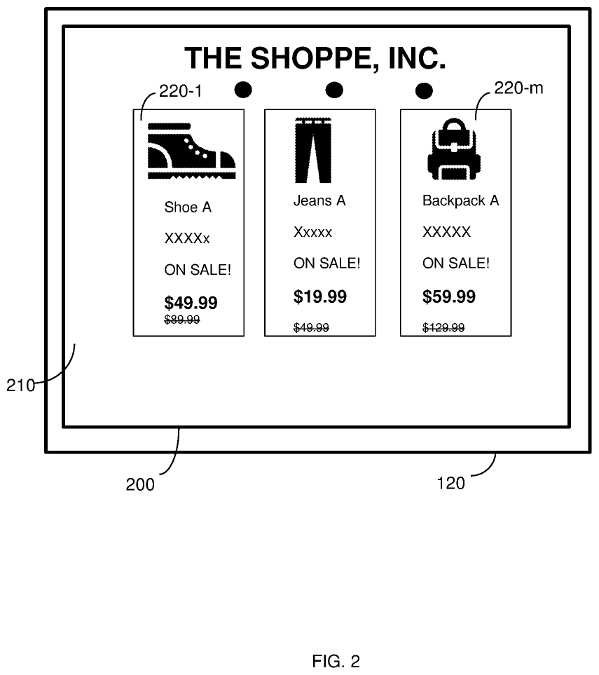

FIG. 2 is a detailed schematic view of an example webpage 200 displayed on a browser of a user device, such as a user device shown in FIG. 1. The web page 200 displays different products in an online catalogue, each of the products represented as an image 220-1 to 220-m (hereinafter image 220 or image 220) of a product for sale on the website 210.

The image 230, upon selection by the user, directs the user to purchase the product. For example, a user may click on the image 220-1, scroll the page to read any associate description, hover a different image or product, place the product associated with the image 220-1 in the cart, and so on. When the purchase is complete, transaction data surrounding the transaction is gathered (e.g., by tracking tags and sent to the server 130. The transaction data may include, for example sales data of other products cross-sold with the selected image 220-1, additional products placed in the cart, the journey until a complete purchase, and so on.

Based on the interaction of the user in purchasing products in the catalogue, transaction, or sales data regarding the purchases may be gathered among users of various user devices 120, aggregated and analyzed to determine various KPIs, for example, those associated with cross-sale information. The KPIs may then be segmented or rearranged based on the user-selectable criteria, and then sent back to the user device 120 for display, as will be discussed in more detailed below.

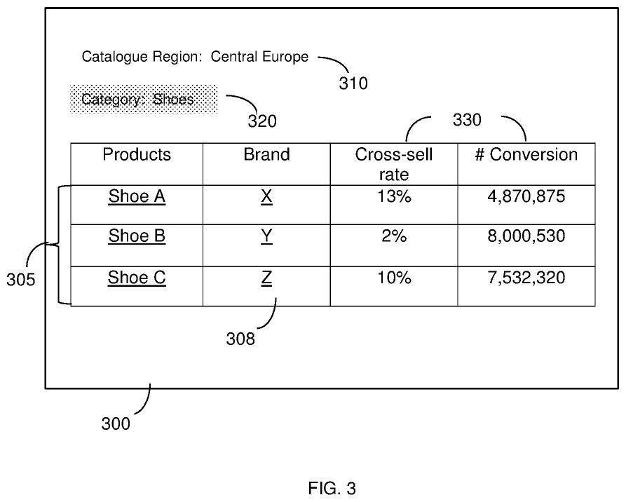

FIG. 3 is a chart 300 depicting sales performance of various products sold within a catalogue, according to an embodiment. The chart 300 shows aggregated sales data for a list of products 305 and their respective brands 308 sold in the catalogue from a particular region 310, and may be displayed on a user display 120. The products 305 and their respective brands 308 are arranged in rows based on segmentation of aggregated sales data into a specific category 320 selectable by a user of the user device 120 who wants to analyze the aggregated sales data. Also, upon selection of one of the individually displayed product 305 or the brand 308, additional detailed information regarding the product 305 or the brand 308 may be displayed.

The chart 300 also displays sales performance of the products arranged as specific KPI 330 that are shown as columns of the chart that is related to cross-selling information. In an embodiment, KPIs including cross-sale rate and a number of conversions for the products may be displayed and compared. Here, the cross sale rate is the percentage of the sales of the product 305 that occurs with another product (as opposed to products that are sold by itself), out of the total number of sales transactions that include product 305, that is the total number of the products 305 that are sold, Also, the number of conversion is a total number of sales transactions that include the product 305 made by the visitors to the website 200.

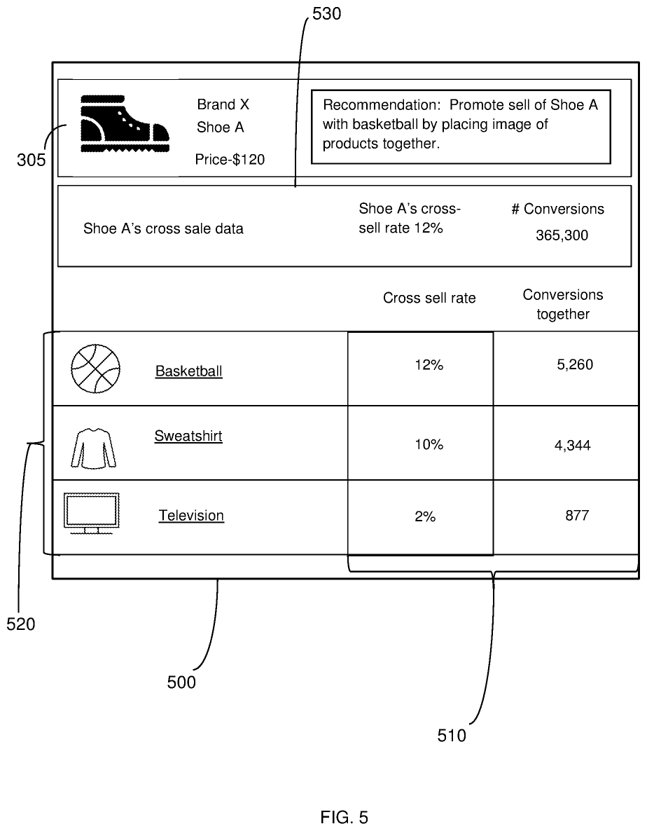

With chart 300, the cross-selling information (i.e., KPI) of the selected products may be compared with other products from the plurality products that are of the same category but of different brands, in terms of the list of products that are cross-sold with those other products. Additionally, cross-selling information of the selected products may be compared with other products of the same brand and category. From the comparison, insights may be gathered from the comparison, as will be explained in more detail in FIG. 5.

For example, as shown in FIG. 3, the products 305 being sold may include shoes A-C, which may be cross-sold with a basketball or other items. Data corresponding to the shoes A-C are ranked based on the decreasing degree of cross-sell rate, and displayed on the user device 120. Also, KPIs including the cross sale rate and the number of conversions based on a total number of sales transactions that include the product 305 made by the visitors to the website 200, may be displayed. Here, a low cross-sell rate despite a high number of conversions may indicate that the product is popular, but is unique on its own and not seen as something that pair well with other products in the eyes of the consumers, as is the case with shoe B. On the other hand, a product 305 with high cross sale rate but, low number of conversions may indicate that the product 305 are more thought of as afterthought or are unpopular on its own.

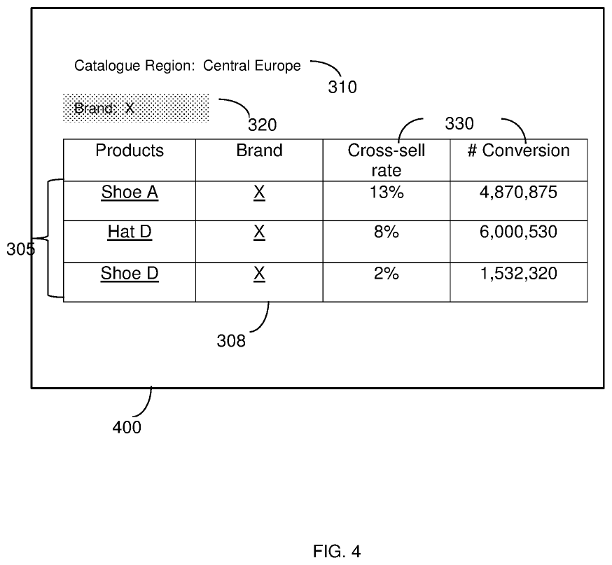

FIG. 4 is a chart 400 showing sales performance of various products sold within a catalogue, according to an embodiment. Here, a list of products may be arranged by the brand 308 of various products 305 of different categories, each with different KPIs 330. Here, given a certain brand X 308, one may ascertain from the number of conversion and cross-sell rate which products 305 the consumers may identify brand X with, and which of the products 305 for the brand 308 may be valuable in drawing additional cross-sales with other products 305 in the catalogue.

FIG. 5 is a chart 500 showing cross-selling data among products, according to an embodiment. Here, the chart 500 shows more detail sales information about a specific product upon selection of “Shoe A” product 305 by the user in FIG. 2. In the embodiment, the chart 500 shows the price of the product 305, as well as KPI 510 for each of the other products 520 cross-sold with the selected product 305. In an embodiment, the KPI 510 may include the cross-sell rate of the other product 520, the number of conversions or sales of the other product 520 cross-sold with the selected product 305. The KPI of the selected product 530 is also shown.

By listing cross-sold products 520 with the selected products 305, as well as ranking the cross-sold products by decreasing cross-sell rate percentage, one may identify, for a selected product 305, the other products 520 that sell well with the selected products 305. Therefore, suggestions may be made to tailor the display of the products to display the cross-selling products together for sale on a website to increase the possibility that the user will select the products and make the purchase. Also, one may also identify products that are always sold by themselves.

As an example, FIG. 5 shows that shoe A, with a price of $120. The KPI information includes that shoe A has a total number of conversions of 365,500 sales, and a cross-sell rate of 12%. A list of products cross-sold with shoe A is also shown, including a basketball, a sweatshirt, and a television. Within the cross sold products, the basketball may account for 12% or 5,260 of the sales cross-sold with shoe A. The sweatshirt may account for 10%, or 4,344 of the sales cross-sold with shoe A. The television, which is an unusual item that is purchased with shoe A, accounts for 2% of the items cross-sold with shoe A in a same transaction.

From the information shown in FIG. 5, one could determine that the basketball is often cross-sold with shoe A, while the fact that the television is sold with shoe A may be coincidental outliers. Based on the information, a recommendation could be issued for the user to create incentives on the website to encourage consumers to buy the basketball with shoe A even more, or place the images of shoe A with the basketball on the website to encourage consumers to further purchase the two items together.

In an embodiment, the KPIs described in FIG. 3-5 may further be analyzed to gain further insights. For example, by analyzing FIG. 5 regarding shoe A, in conjunction with FIG. 3 with other products 305 in the same category 320 such as shoe B, which has a much lower cross-sell rate as compared to shoe A, it may be recommended to cross-sell these lone-selling shoe B with the basketballs to improve cross-selling performance of shoe B by encouraging consumers to further purchase the two items together.

In an embodiment, the list of other products 502 cross-sold with shoe A may be compared to the KPI (e.g., cross sell rate and number of conversions together) of the list of other products cross-sold with that of another shoe brand, that is, shoe B that would be displayed upon selection of shoe B in FIG. 3, or other shoes D sold by the same company. In an embodiment, the cross-selling information for shoe A, a sneaker, may be compared with that of shoe D, a dress-shoe, which may reveal a much lower cross-sell rate with basketballs, but perhaps a higher cross-sell rate or conversion number for some other products, such as suits.

It is noted that the segmentation, or grouping of transaction data including the KPI and the cross-selling information as described in FIG. 3-5 above is based on the geographic region 310 where the transaction data is collected, such as Central Europe. However the KPI including the cross-selling information for a selected product 305 may also be segmented between customers who live in Asia, as opposed to those living in the United States or Europe. Also, in an embodiment, the KPI including the cross-selling information for the selected product 305 may further be segmented based on different user-selected parameters or categories, such as for a given population of users, the media used by the visitors to the website 210 in order to purchase the products. For example, cross-selling information may be segmented for the visitors who use social media platforms to visit the website 210 and make the purchases. The transaction data being segmented or grouped based on the selected parameters or categories can then be further analyzed to determine KPIs associated with the cross-sale information, and then displayed as charts 300-500 described in FIG. 3-5 depending on selections made by a viewer analyzing the cross-sale information.

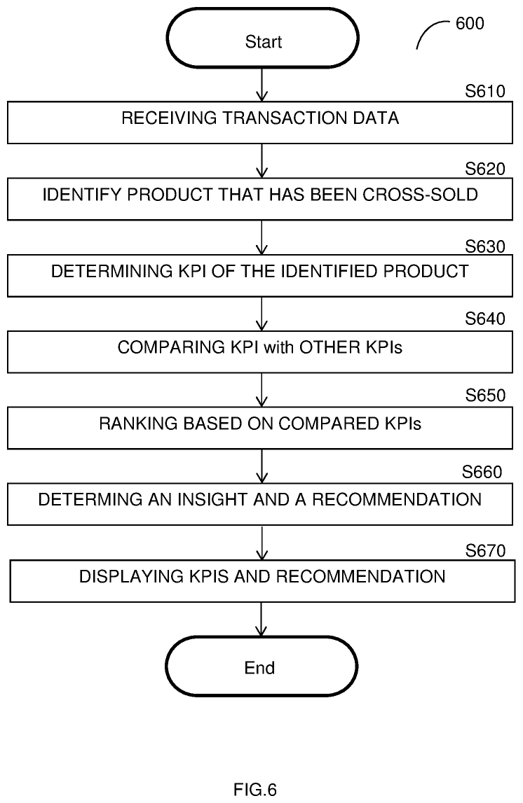

FIG. 6 is a diagram of a method 600 of analyzing an activity of a user, according to an embodiment. At S610, transaction data is received on a plurality of products. The data may include a number of transactions in which each of the plurality of products are sold. As noted above, such data is collected by tracking tags embedded in monitored webpages. Next, at S620, a product from the plurality of products that are cross-sold together with at least another product from the plurality of products in a same transaction is identified.

In an embodiment, the product from the plurality of products may be identified as being cross-sold with at least another product from the plurality of products in the same transaction when they both appear on an electronic receipt file documenting the transaction and listing the products as being sold in the same transaction. The receipt may be stored on the user device, or elsewhere on a server or database. In another embodiment, the product from the plurality of products is being identified as being cross-purchased online by the tracking the action of the user, through the user's section of the product with other products to be placed on a cart, followed by selecting to purchase the products simultaneously in the same transaction. Tracking may be done on aggregate multiple transactions to arrive at an aggregate result.

Thereafter, at S630, a KPI is determined for both the identified product and for other products cross-sold with the identified product. In an embodiment, the KPI may include the number of conversions and the cross-sell rate. Here, the number of conversions is a total number of sales transactions that include a particular product, made by visitors to the website. Also, the cross-sell rate for the identified product is determined based on the number of conversions and the determined number of times the identified product has been sold together with the at least another product from the plurality of products in the same transaction. In one embodiment, the cross-sale rate may be determined by comparing the number of times the identified product has been sold together with at least another product that is identified from the plurality of products in the same transaction against a total number of times the identified product is sold.

Thereafter, at S640, the KPIs of the products are compared. Then, based on the comparison, in S650 the KPIs of the products are ranked based on the comparison. Afterwards, at S660, an insight is determined, from which a recommendation is formed based on the insight. Thereafter, at S670, the KPIs and the recommendation are displayed for the website owner.

For example, and referring to FIG. 5, sales data from a plurality of products in a catalogue that sold on a website is received for view by the website owner. Upon the website owner's selection of the product, such as Shoe A, various other products that are cross-sold with shoe A, such as a basketball, a sweatshirt, or a television, are identified by reviewing the electronic receipts evidencing the sale of these goods together. Then, the KPIs for these products including the cross-sale rate and number of conversions are calculated. In comparing the shoe A's KPI with the basketball, insight may be gained that there is a high cross-sell rate and number of conversions being sold together in the same transaction. Therefore, a recommendation is then made to promote the sale of Shoe A with the basketball by placing the image of the products together.

In another example, the KPI including the cross-selling information for Shoe A may further be segmented for the visitors who use social media platforms to visit the website 210 and make the purchases. The transaction data for those who use the social media platform to purchase Shoe A can then be further analyzed to determine KPIs associated with the cross-sale information, and then displayed as charts 300-500 described in FIG. 3-5 depending on selections made by a viewer analyzing the cross-sale information.

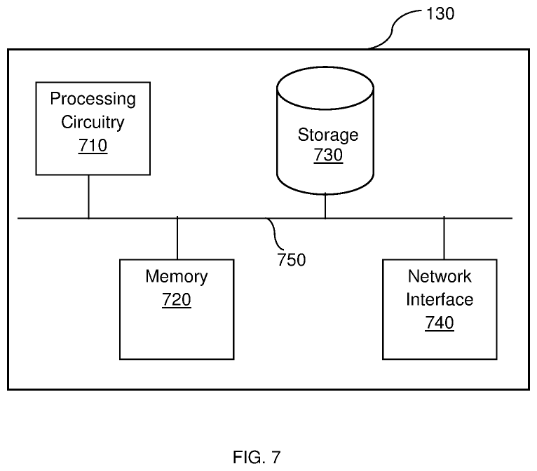

FIG. 7 is an example block diagram of an analytic engine 130 according to an embodiment. The analytic engine 130, which operate as a system that implement the method as described above in FIG. 7 includes a processing circuitry 710 coupled to a memory 720, a storage 730, and a network interface 740. In an embodiment, the components of the analytic engine 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 720 may be volatile (e.g., RAM, etc.), non-volatile (e.g., ROM, flash memory, etc.), or a combination thereof. In one configuration, computer readable instructions to implement one or more embodiments disclosed herein may be stored in the storage 730.

In another embodiment, the memory 720 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, CD-ROM, Digital Versatile Disks (DVDs), or any other medium which can be used to store the desired information.

The network interface 740 allows the analytic engine 130 to communicate with the web server 140 for the purpose of, for example, receiving data, sending data, and the like. Further, the network interface 740 allows the analytic engine 130 to communicate with the database 150 for the purpose of collecting sales data.

It should be understood that the embodiments described herein are not limited to the specific architecture illustrated in FIG. 7, and other architectures may be equally used without departing from the scope of the disclosed embodiments. It should be further that noted that the analytic server 130 may be integrated in a cloud computing platform, such a public or private cloud.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for identifying cross-selling effectiveness, comprising:
receiving, at a processor of an analytic server, transaction data on a plurality of products from a database;
identifying a product from the plurality of products that is sold together with a target product from the plurality of products in respective transactions across a plurality of transactions;
determining, using the processor, a Key Performance Indicator (KPI) of the identified product corresponding to the target product, based on the received transaction data;
comparing, using the processor, the KPI of the identified product with a second KPI of a second product from the plurality of products, the second KPI determined based on transactions including the second product and the target product;
ranking the identified product and the second product based on the comparison;
determining, using the processor, an insight based on the ranking, the insight indicating that the identified product ranked above the second product in KPI corresponding to the target product; and
causing a recommendation to be displayed on a browser of a user device, the recommendation including an indication to sell the identified product with the target product based on the insight.

2. The method of claim 1, further comprising:
causing display, on the browser of the user device, the KPI of the identified product, the KPI of the second product, and the recommendation.

3. The method of claim 1, wherein the determining the KPI of the identified product includes one of:
determining a number of conversions for the plurality of products; or
determining a cross-sale rate for the identified product.

4. The method of claim 3, wherein the number of conversions is a number of times the identified product has been sold together with the target product from the plurality of products in same transactions.

5. The method of claim 3, wherein the cross-sell rate is determined based on the number of conversions and a determined number of times the identified product has been sold in total.

6. The method of claim 3, further comprising performing a segmentation of the KPI of the identified product.

7. The method of claim 6, wherein the segmentation is performed based on a geographic region of a purchaser of the identified product.

8. The method of claim 2, wherein the displaying the KPI of the identified product is based on a category of the identified product.

9. The method of claim 2 wherein the displaying the KPI of the identified product is based on a region in which the identified product is sold.

10. A non-transitory computer readable medium having stored thereon instructions for causing a processing circuitry to execute a process, the process comprising:
receiving, at a processor of an analytic server, transaction data on a plurality of products from a database;
identifying a product from the plurality of products that is sold together with a target product from the plurality of products in respective transactions across a plurality of transactions;
determining using the processor, a Key Performance Indicator (KPI) of the identified product corresponding to the target product, based on the received transaction data;
comparing the KPI of the identified product with a second KPI of a second product from the plurality of products, the second KPI determined based on transactions including the second product and the target product;
ranking the identified product and the second product based on the comparison;
determining, using the processor, an insight based on the ranking, the insight indicating that the identified product ranked above the second product in KPI corresponding to the target product; and
causing a recommendation to be displayed, on a browser of a user device, the recommendation including an indication to sell the identified product with the target product based on the insight.

11. A system for identifying cross-selling effectiveness, comprising:
a processing circuitry; and
a memory, the memory containing instructions that, when executed by the processing circuitry, configure the system to:
receive transaction data on a plurality of products from a database;
identify a product from the plurality of products that is sold together with a target product from the plurality of products in respective transactions across a plurality of transactions;
determine a Key Performance Indicator (KPI) of the identified product corresponding to the target product, based on the received transaction data;
compare the KPI of the identified product with a second KPI of a second product from the plurality of products, the second KPI determined based on transactions including the second product and the target product;
rank the identified product and the second product based on the comparison;
determine an insight based on the ranking, the insight indicating that the identified product ranked above the second product in KPI corresponding to the target product; and
causing a recommendation to be displayed on a browser of a user device, the recommendation including an indication to sell the identified product with the target product based on the insight.

12. The system of claim 11, wherein the system further includes a display screen to display, on the browser the KPI of the identified product, the KPI of the second product, and the recommendation.

13. The system of claim 11, wherein the determining the KPI of the identified product includes one of:
determining a number of conversions for the plurality of products; or
determining a cross-sale rate for the identified product.

14. The system of claim 13, wherein the number of conversions is a number of times the identified product has been sold together with the target product from the plurality of products in same transaction.

15. The system of claim 14, wherein the cross-sell rate is determined based on the number of conversions and a determined number of times the identified product has been sold in total.

16. The system of claim 13, wherein the system is further configured to perform a segmentation of the KPI of the identified product.

17. The system of claim 16, wherein the segmentation is performed based on a geographic region of a purchaser of the identified product.

18. The system of claim 12, wherein the displaying the KPI of the identified product is based on a category of the identified product.

19. The system of claim 12, wherein the displaying the KPI of the identified product is based on a region in which the identified product is sold.
